(19) United States
(12) Patent Application Publication
(10) Pub. No.: US 2025/0079748 A1
(43) Pub. Date: Mar. 6, 2025

(54) Connector

(71) Applicant: Tyco Electronics (Shanghai) Co., Ltd., Shanghai (CN)

(72) Inventors: Qianjin (Orando) Li, Shanghai (CN); YuQiang (Thomas) Zhao, Shanghai (CN)

(73) Assignee: Tyco Electronics (Shanghai) Co., Ltd., Shanghai (CN)

(21) Appl. No.: 18/824,514

(22) Filed: Sep. 4, 2024

(30) Foreign Application Priority Data
Sep. 5, 2023 (CN) 202311141604.3

(51) Int. Cl. H01R 13/506; H01R 4/02; H01R 13/6581

(52) U.S. Cl. CPC H01R 13/506; H01R 4/023; H01R 13/6581

(57) ABSTRACT

A connector includes a housing, a first terminal disposed in the housing and having a first elastic contact part and a first welding part, and a first wire extending into the housing and welded to the first welding part of the first terminal. The first elastic contact part extends along a longitudinal direction of the housing to electrically contact a first mating terminal inserted along the longitudinal direction. A surface of the first welding part is parallel to a height direction of the housing. The first wire extends into the housing along the height direction and is welded to the surface of the first welding part.

### CROSS-REFERENCE TO RELATED APPLICATION

This application claims the benefit of the filing date under 35 U.S.C. § 119 (a)-(d) of Chinese Patent Application No. 202311141604.3, filed on Sep. 5, 2023.

### FIELD OF THE INVENTION

The present invention relates to a connector, in particular to a power connector.

### BACKGROUND OF THE INVENTION

A power connector typically includes a housing and a pair of power terminals. The power terminal is set in the housing. The power terminal has an elastic contact part and a welding part. The elastic contact part of the power terminal extends along the longitudinal direction of the housing and is used for electrical contact with a mating connector, while the welding part of the power terminal is used for welding to a wire.

When the wire is inserted into the housing along the longitudinal direction of the housing, there is no need to bend the wire because the insertion direction of the wire is consistent with the extension direction of the elastic contact part of the power terminal. However, when the wire is inserted into the housing in a direction perpendicular to the longitudinal direction of the housing, the wire needs to be bent 90 degrees, which generates significant bending stress and affects the floating contact performance of the connector.

### SUMMARY OF THE INVENTION

A connector includes a housing, a first terminal disposed in the housing and having a first elastic contact part and a first welding part, and a first wire extending into the housing and welded to the first welding part of the first terminal. The first elastic contact part extends along a longitudinal direction of the housing to electrically contact a first mating terminal inserted along the longitudinal direction. A surface of the first welding part is parallel to a height direction of the housing. The first wire extends into the housing along the height direction and is welded to the surface of the first welding part.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment when viewed from a front side;

FIG. 2 shows an illustrative perspective view of a connector according to an exemplary embodiment when viewed from a rear side;

FIG. 3 shows an illustrative perspective view of a connector according to an exemplary embodiment when viewed from the rear, where a back cover is opened;

FIG. 4 shows an illustrative exploded view of a connector according to an exemplary embodiment;

FIG. 5 shows an illustrative assembly view of terminals and auxiliary terminals of a connector according to an exemplary embodiment;

FIG. 6 shows an illustrative exploded view of terminals and auxiliary terminals of a connector according to an exemplary embodiment; and

FIG. 7 shows an illustrative perspective view of the housing and shielding component of a connector according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

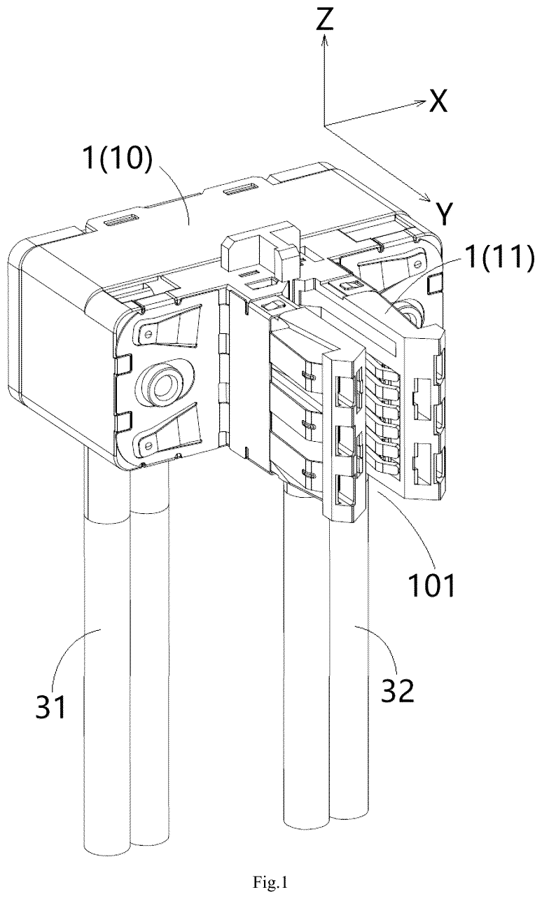

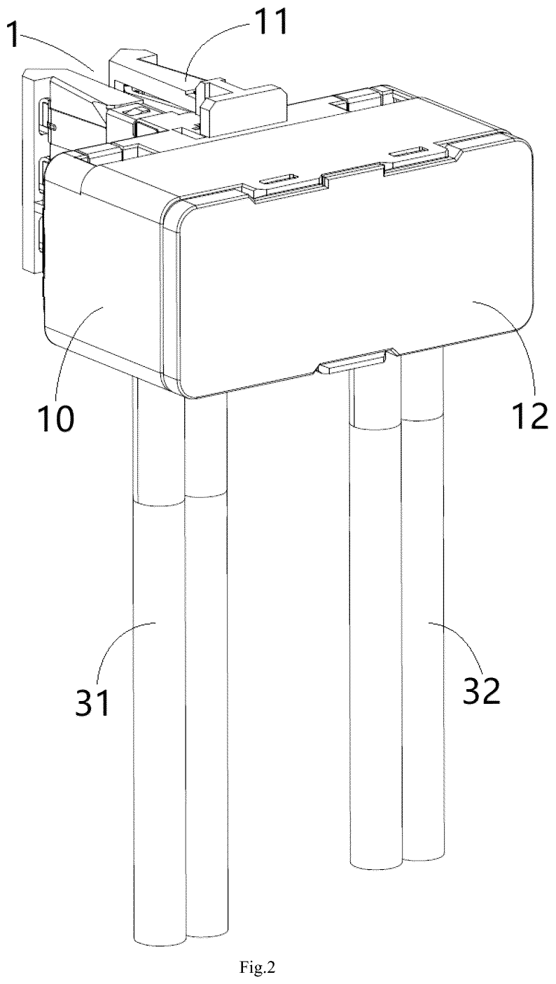

As shown in FIGS. 1 to 4, in an exemplary embodiment of the present invention, a connector is disclosed. The connector includes a housing 1, a first terminal 21, and a first wire 31. The first terminal 21 is arranged in the housing 1 and includes a first elastic contact part 211 and a first welding part 210. The first wire 31 extends into the housing 1 and is welded to the first welding part 210 of the first terminal 21.

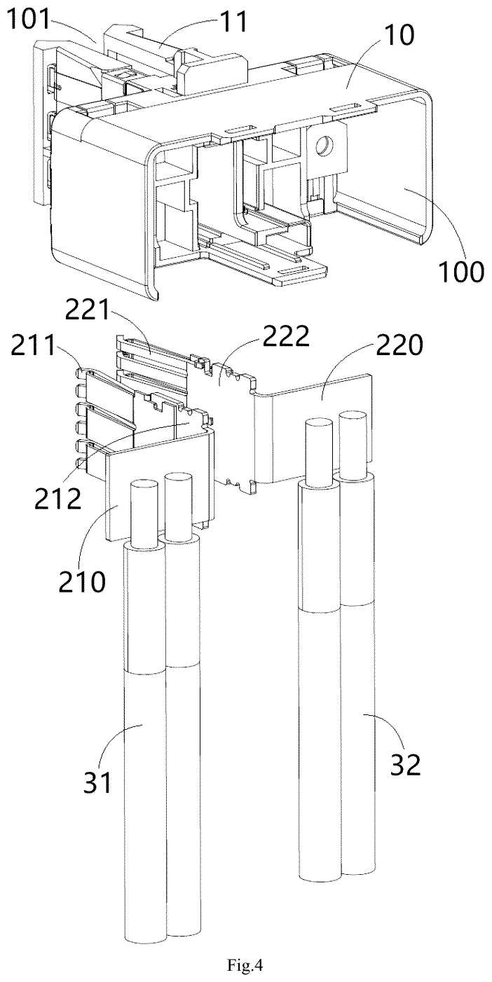

As shown in FIG. 4, in the illustrated embodiments, the first elastic contact part 211 extends along a longitudinal direction Y of the housing 1 for electrical contact with a first mating terminal inserted along the longitudinal direction Y of the housing 1. A surface of the first welding part 210 is parallel to a height direction Z of the housing 1, and the first wire 31 extends into the housing 1 along the height direction Z of the housing 1 and is welded to the surface of the first welding part 210. The height direction Z is perpendicular to the longitudinal direction Y.

As shown in FIGS. 1 to 4, in the illustrated embodiments, the connector further comprises a second terminal 22 and a second wire 32. The second terminal 22 is provided in the housing 1 and includes a second elastic contact part 221 and a second welding part 220. The second wire 32 extends into the housing 1 and is welded to the second welding part 220 of the second terminal 22. The second elastic contact part 221 extends along the longitudinal direction Y of the housing 1 for electrical contact with a second mating terminal inserted along the longitudinal direction Y of the housing 1. The surface of the second welding part 220 is parallel to the height direction Z of the housing 1, and the second wire 32 extends into the housing 1 along the height direction Z and is welded to the surface of the second welding part 220.

As shown in FIGS. 1 to 4, in the illustrated embodiments, the housing 1 comprises a front part 11 and a rear part 10 opposite to each other in its longitudinal direction Y, and an accommodating chamber 100 is formed in the rear part 10 of the housing 1. The first welding part 210 and the second welding part 220 are accommodated in the accommodating chamber 100, and the first wire 31 and the second wire 32 extend into the accommodating chamber 100.

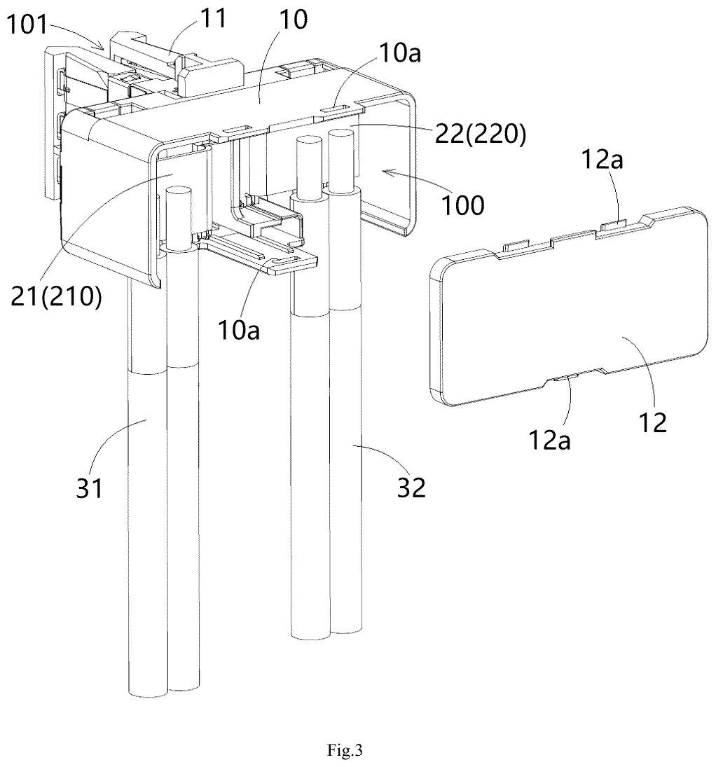

As shown in FIG. 3, in the illustrated embodiments, a first socket and a second socket are formed in the bottom wall of the rear part 10 of the housing 1. The first wire 31 and the second wire 32 are respectively inserted into the accommodating chamber 100 through the first and second sockets.

As shown in FIGS. 1 to 4, in the illustrated embodiments, a slot 101 is formed on the front part 11 of the housing 1, which allows for the insertion of a mating plug of a mating connector. The slot 101 extends along the longitudinal direction Y and height direction Z of the housing 1. The slot 101 has left and right sides opposite to each other in the transverse direction of the housing 1, and the first elastic contact part 211 and the second elastic contact part 221 are respectively set at the left and right sides inside slot 101.

As shown in 5 and 6, in the illustrated embodiments, the first elastic contact part 211 includes multiple first elastic arms 211a extending along the longitudinal direction Y of the housing 1. The multiple first elastic arms 211a are arranged in a row in the height direction Z of the housing 1 for electrical contact with a first mating terminal on the mating plug inserted into slot 101. The second elastic contact part 221 includes multiple second elastic arms 221a extending along the longitudinal direction Y of the housing 1. The multiple second elastic arms 221a are arranged in a row in the height direction Z of the housing 1 for electrical contact with a second mating terminal on the mating plug inserted into slot 101.

As shown in FIGS. 1 to 4, in the illustrated embodiments, the accommodating chamber 100 of the housing 1 has a rear opening that opens backwards. The connector also includes a back cover 12, which is installed on the rear opening of the accommodating chamber 100. In the illustrated embodiments, a snap slot 10a is formed on the circumferential wall of the rear opening of the accommodating chamber 100, and a buckle 12a is formed on the periphery of the back cover 12. The buckle 12a is engaged in the snap slot 10a to fix the back cover 12 to the housing 1.

As shown in FIGS. 1 to 4, in the illustrated embodiments, the housing 1 has left and right sides opposite to each other in its transverse direction X, and the first terminal 21 and the second terminal 22 are symmetrically arranged at the left and right sides inside the housing 1.

As shown in FIGS. 4 to 6, in the illustrated embodiments, the first terminal 21 further includes a first fixing part 212 located between the first elastic contact part 211 and the first welding part 210, which is fixed to the housing 1. The second terminal 22 also includes a second fixing part 222 located between the second elastic contact part 221 and the second welding part 220, which is fixed to the housing 1.

As shown in FIGS. 4 to 6, in the illustrated embodiments, the first welding part 210 and the second welding part 220 are in a flat shape and extend along the transverse direction X and height direction Z of the housing 1. The first fixing part 212 and the second fixing part 222 are in a flat shape and extend along the longitudinal direction Y and height direction Z of the housing 1.

As shown in FIG. 4, in the illustrated embodiments, the first elastic contact part 211 and the second elastic contact part 221 have inner faces facing each other and outer faces opposite to each other. The first fixing part 212 and the second fixing part 222 have inner surfaces facing each other and outer surfaces opposite to each other.

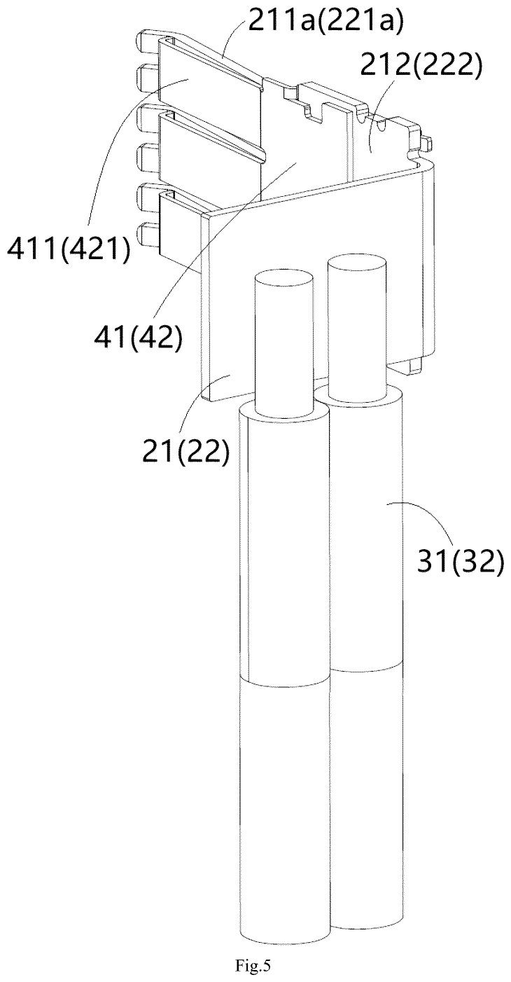

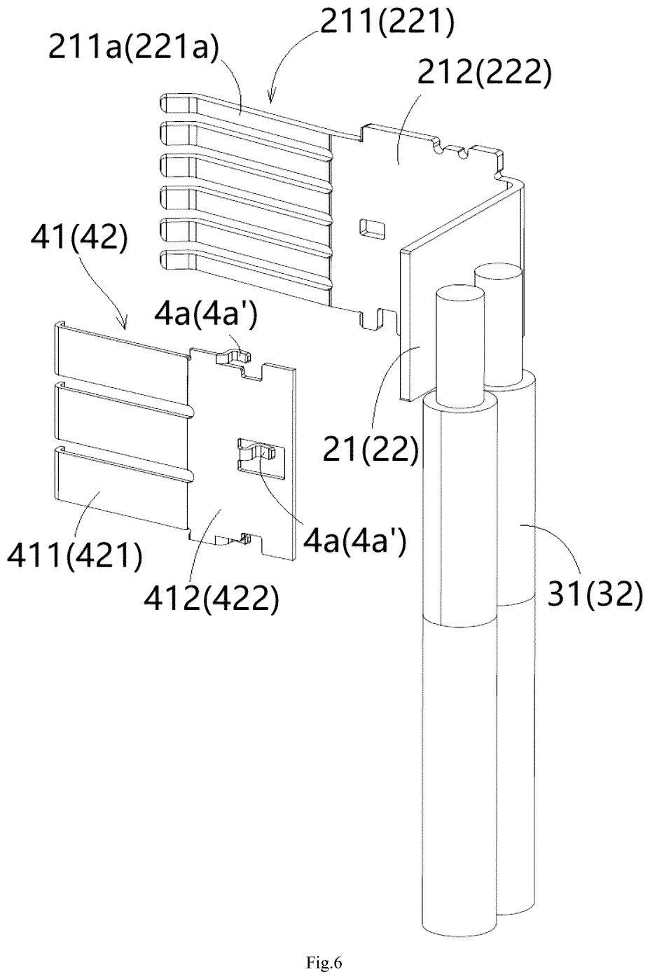

The connector also includes, as shown in FIGS. 5 and 6, a first auxiliary terminal 41 and a second auxiliary terminal 42. The first auxiliary terminal 41 is installed on the outer surfaces of the first elastic contact part 211 and the first fixing part 212 of the first terminal 21 to enhance the mechanical strength of the first terminal 21. The second auxiliary terminal 42 is installed on the outer surfaces of the second elastic contact part 221 and the second fixing part 222 of the second terminal 22 to enhance the mechanical strength of the second terminal 22.

As shown in FIGS. 5 and 6, in the illustrated embodiments, the first auxiliary terminal 41 includes a first base plate 412 and multiple first auxiliary elastic arms 411, the multiple first auxiliary clastic arms 411 are connected to the first base plate 412, the first base plate 412 is stacked and fixed on the outer surface of the first fixing part 212, and the ends of the multiple first auxiliary elastic arms 411 are pressed against the outer surface of the first elastic contact part 211.

As shown in FIGS. 5 and 6, in the illustrated embodiments, the second auxiliary terminal 42 includes a second base plate 422 and multiple second auxiliary elastic arms 421, the multiple second auxiliary clastic arms 421 are connected to the second base plate 422, the second base plate 422 is stacked and fixed on the outer surface of the second fixing part 222, and the ends of the multiple second auxiliary clastic arms 421 are pressed against the outer surface of the second elastic contact part 221.

As shown in FIGS. 4 to 6, in the illustrated embodiments, a first elastic buckle 4a is formed on the first base plate 412, and the first elastic buckle 4a is locked onto the first fixing part 212 to fix the first base plate 412 onto the first fixing part 212. A second elastic buckle 4a′ is formed on the second base plate 422, and the second elastic buckle 4a′ is locked onto the second fixing part 222 to fix the second base plate 422 onto the second fixing part 222.

As shown in FIG. 4, in the illustrated embodiments, the connector comprises multiple first wires 31, which are welded onto the surface of the first welding part 210. The connector includes multiple second wires 32, which are welded onto the surface of the second welding part 220.

As shown in FIGS. 1 to 4 and 7, in the illustrated embodiments, the front part 11 of the housing 1 is tongue shaped and protrudes forward from the front wall of the rear part 10 of the housing 1, suitable for insertion into a mating housing of the mating connector.

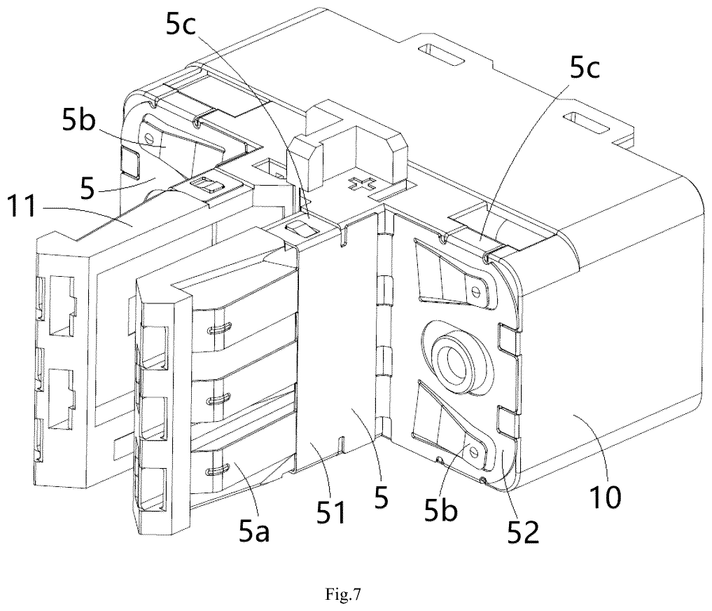

As shown in FIG. 7, in the illustrated embodiments, the connector further comprises a pair of shielding components 5, which are respectively located at the left and right sides of the front part 11 of the housing 1 and installed on the outer side of the housing 1, for electrical contact with a mating shielding component of the mating connector. The shielding component 5 includes a first plate portion 51 and a second plate portion 52. The first plate portion 51 is attached to the outer side of the front part 11 of the housing 1 and formed with a first elastic contact arm 5a suitable for electrical contact with a mating shielding component. The second plate portion 52 is attached to the outer side of the front wall of the rear part 10 of the housing 1 and formed with a second clastic contact arm 5b suitable for electrical contact with the mating shielding component. In the illustrated embodiments, elastic buckles 5c are formed on the first plate portion 51 and the second plate portion 52, respectively. The elastic buckle 5c is clamped onto the housing 1 to secure the shielding component 5 to the outer side of the housing 1.

In the aforementioned exemplary embodiments of the present invention, the wire is inserted into the housing along the height direction of the housing and does not need to be bent. Therefore, there is no bending stress generated and it does not affect the floating contact performance of the connector.

In the illustrated embodiments, the connector is a power connector, the first terminal 21 and the second terminal 22 are power terminals, and each of the first terminal 21 and the second terminal 22 is an integral stamped part. This can reduce manufacturing costs.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing;
a first terminal disposed in the housing and having a first elastic contact part and a first welding part, the first elastic contact part extends along a longitudinal direction of the housing to electrically contact a first mating terminal inserted along the longitudinal direction, a surface of the first welding part is parallel to a height direction of the housing; and
a first wire extending into the housing and welded to the first welding part of the first terminal, the first wire extends into the housing along the height direction and is welded to the surface of the first welding part.

2. The connector according to claim 1, further comprising:
a second terminal disposed in the housing and having a second elastic contact part and a second welding part, the second elastic contact part extends along the longitudinal direction of the housing to electrically contact a second mating terminal inserted along the longitudinal direction, a surface of the second welding part is parallel to the height direction of the housing; and
a second wire extending into the housing and welded to the second welding part of the second terminal, the second wire extends into the housing along the height direction and is welded to the surface of the second welding part.

3. The connector according to claim 2, wherein the housing has a front part and a rear part opposite to each other in the longitudinal direction, an accommodating chamber is formed in the rear part of the housing, the first welding part and the second welding part are accommodated in the accommodating chamber, the first wire and the second wire extend into the accommodating chamber.

4. The connector according to claim 3, wherein a first socket and a second socket are formed in a bottom wall of the rear part of the housing, the first wire and the second wire are respectively inserted into the accommodating chamber through the first socket and the second socket.

5. The connector according to claim 3, wherein a slot is formed in the front part of the housing and allows insertion of a mating plug of a mating connector, the slot extends along the longitudinal direction and the height direction of the housing, the slot has a left side and a right side opposite to each other in a transverse direction of the housing, the first elastic contact part and the second elastic contact part are respectively set at the left side and the right side inside the slot.

6. The connector according to claim 5, wherein the first elastic contact part includes a plurality of first elastic arms extending along the longitudinal direction of the housing, the first elastic arms are arranged in a row in the height direction of the housing to electrically contact the first mating terminal on the mating plug inserted into the slot, the second elastic contact part includes a plurality of second elastic arms extending along the longitudinal direction of the housing, the second elastic arms are arranged in a row in the height direction of the housing for electrical contact with the second mating terminal on the mating plug inserted into the slot.

7. The connector according to claim 4, wherein the accommodating chamber of the housing has a rear opening that opens backwards, the connector further comprises a back cover installed on the rear opening of the accommodating chamber.

8. The connector according to claim 7, wherein a snap slot is formed on a circumferential wall of the rear opening of the accommodating chamber, a buckle is formed on a periphery of the back cover, the buckle is engaged in the snap slot to fix the back cover to the housing.

9. The connector according to claim 2, wherein the housing has a left side and a right side opposite to each other in a transverse direction, the first terminal and the second terminal are symmetrically arranged at the left side and the right side inside the housing.

10. The connector according to claim 9, wherein the first terminal has a first fixing part between the first elastic contact part and the first welding part, the first fixing part is fixed to the housing, the second terminal has a second fixing part between the second elastic contact part and the second welding part, the second fixing part is fixed to the housing.

11. The connector according to claim 10, wherein the first welding part and the second welding part are in a flat shape and extend along the transverse direction and height direction of the housing, the first fixing part and the second fixing part are in a flat shape and extend along the longitudinal direction and the height direction of the housing.

12. The connector according to claim 11, wherein the first elastic contact part and the second elastic contact part have inner surfaces facing each other and outer surfaces opposite to each other, the first fixing part and the second fixing part have inner surfaces facing each other and outer surfaces opposite to each other, the connector further comprises:
a first auxiliary terminal on the outer surfaces of the first elastic contact part and the first fixing part; and/or
a second auxiliary terminal on the outer surfaces of the second elastic contact part and the second fixing part.

13. The connector according to claim 12, wherein the first auxiliary terminal includes a first base plate and a plurality of first auxiliary elastic arms connected to the first base plate, the first base plate is stacked and fixed on the outer surface of the first fixing part, a plurality of ends of the first auxiliary elastic arms are pressed against the outer surface of the first elastic contact part.

14. The connector according to claim 13, wherein the second auxiliary terminal includes a second base plate and a plurality of second auxiliary elastic arms connected to the second base plate, the second base plate is stacked and fixed on the outer surface of the second fixing part, a plurality of ends of the second auxiliary elastic arms are pressed against the outer surface of the second elastic contact part.

15. The connector according to claim 14, wherein a first elastic buckle is formed on the first base plate and is locked onto the first fixing part to fix the first base plate onto the first fixing part, a second elastic buckle is formed on the second base plate and is locked onto the second fixing part to fix the second base plate onto the second fixing part.

16. The connector according to claim 2, wherein the first wire is one of a plurality of first wires welded onto the surface of the first welding part, and the second wire is one of a plurality of second wires welded onto the surface of the second welding part.

17. The connector according to claim 3, wherein the front part of the housing is tongue shaped and protrudes forward from a front side wall of the rear part of the housing, the tongue is insertable into a mating housing of a mating connector.

18. The connector according to claim 17, further comprising a pair of shielding components respectively located at a left side and a right side of the front part of the housing, the shielding components are installed on an outer side of the housing to electrical contact with a mating shielding component of the mating connector.

19. The connector according to claim 18, wherein each of the shielding components includes:
a first plate portion attached to the outer side of the front part of the housing and having a first elastic contact arm electrical contacting the mating shielding component; and
a second plate portion attached to an outer side of a front wall at the rear part of the housing and having a second elastic contact arm electrical contacting the mating shielding component, a plurality of elastic buckles are respectively formed on the first plate portion and the second plate portion, the elastic buckles are locked onto the housing to fix the shielding components to the outer side of the housing.

20. The connector according to claim 2, wherein the connector is a power connector, the first terminal and the second terminal are power terminals, and each of the first terminal and the second terminal is an integral stamped part.
